(19) United States
(12) Patent Application Publication
(10) Pub. No.: US 2008/0270150 A1
(43) Pub. Date: Oct. 30, 2008

(54) SYSTEMS AND METHODS OF REPAIR AND OPERATIONS PLANNING

(75) Inventor: Marcus V.A. Verol, Rio de Janeiro (BR)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture Global Services GmbH, Schaffhausen (CH)

(21) Appl. No.: 11/740,547

(22) Filed: Apr. 26, 2007

(51) Int. Cl. G06Q 10/00

(52) U.S. Cl. 705/1

(57) ABSTRACT

Systems and methods for repair and operation planning are provided in order to maximize efficiency of a company. The speed in repairing equipment and the availability of spare parts are vital in order to maintain a client base. The systems and methods provided analyze the spare parts repair history and other factors in order to integrate many departments of a company.

### FIELD OF THE INVENTION

The present invention relates generally to the maintenance of services companies. More particularly the present invention relates to the implementation of a systems and methods for repairing and operations planning improvements. Even more particularly, the present invention relates to the maintenance of service companies to reduce the percentage of disruption in services due to operational and maintenance problems.

### BACKGROUND

It is widely known among supply chain professionals to implement sales and operations processes. These processes improve the efficiency of sales and operations for companies that depend on high turnaround of product. The sales and operation planning is important among supply chain professionals. However, when approaching a services provider that depends on the reliability of its equipment, an important process is the repair and operations planning. The repair and operations planning process is important for a services company, mainly if it operates in a market that is already mature and with competition. In these markets, where the sales do not exhibit great growth, the speed of repairing equipment and the availability of spare parts are important for the maintenance of the client's base. In many industries, an uninterrupted operation is key, as contractual penalties due to a lesser availability may severely affect the company's revenues.

It would therefore be desirable to enlist a process that assists in the maintenance planning by analyzing the spare parts repair history. It would also be desirable to provide a system that solves the problem of disruption of services due to operational and maintenance. It would also be desirable to provide a system to balance the demand for spare parts and the availability.

### SUMMARY

In accordance with aspects of the invention, a method for repair and operations planning is provided. The method includes collecting input data from at least one department and evaluating the input data. Once the input data is evaluated, the method includes meeting to form an integrated plan to improve repair and operations efficiency.

In accordance with another aspect of the invention, a method for repair and operations planning is provided where input data is collected from a logistics and procurement department, an operations and maintenance department, an engineering department and a finance department.

In accordance with still another aspect of the invention, a method for repair and operations planning is provided where the input data is evaluated against a key performance indicator. Key performance indicators are selected from the group of group consisting of total inventory of the spare parts (in number of items and $$); number of preventive maintenance activities executed within the period; percent of disruption in the services provided; loss of revenues due to the interruption of services; number of spare parts movements; penalties imposed to service providers for faulty maintenance; Mean Time between Failure; Mean Time to Repair of critical equipment or combinations thereof.

In accordance with aspects of the invention, a method for repair and operations planning is provided where the integrated plan includes a focal point. The focal point is selected from the group consisting of sharing forecast information; inventory status; those in repair, planned purchases, stock redistribution; critical materials; seasonal changes; maintenances; controlling the budget for purchasing spare parts and combinations thereof.

In accordance with other aspects of the present invention, a system for improving maintenance planning for repair and operations is provided. The system includes a preparation phase whereby input data is collected from at least one department; a first operations and maintenance phase whereby the input data is collected; a repair and operations meeting phase whereby the input data is evaluated; and a second operations and maintenance phase whereby an integrated plan is developed based on the evaluation of the input data.

Some embodiments of the invention may include or utilize computer-executable instructions for performing one or more of the disclosed methods. The computer-executable instructions may be stored on a computer-readable medium, such as a portable memory drive or CD-ROM.

### BRIEF DESCRIPTION OF THE DRAWINGS

FIG. 1 illustrates a flowchart of a repair and operations planning system in accordance with an embodiment of the invention.

FIG. 2 illustrates a flowchart of an embodiment of the preparation step of a repair and operations planning system in accordance with an embodiment of the invention.

FIG. 3 illustrates a flowchart of an embodiment of one step of a repair and operations planning system in accordance with an embodiment of the invention.

FIG. 4 illustrates a flowchart of an embodiment of one step of a repair and operations planning system in accordance with an embodiment of the invention.

FIG. 5 illustrates a flowchart of an embodiment of the one step of a repair and operations planning system in accordance with an embodiment of the invention.

### DETAILED DESCRIPTION

Systems and methods for repair and operations planning are provided. In some industries, it is often easier and more profitable to maintain existing clients versus capturing new ones. Capturing new clients typically involves extensive sales and operations planning. The adoption of sales and operations planning processes has been growing over the years. The sales and operations planning processes aim at the achievement of improvements both in terms of the cost (inventory levels and production costs) and also the service (product availability). In accordance with the teachings of embodiments of the present invention, balancing between not only the demand and the availability of products is taken into account, but also achievement of improvements in operations and maintenance. The present repair and operations planning systems and methods provide their current clients with non-disruption of services due to operational and maintenance problems.

In accordance with embodiments of the present invention, the balancing of spare parts inventories is as important as the balancing of products inventories. Similar to gaps among commercial, supply and logistics areas, which the sales and operations planning processes aim at solving, many companies utilize operations and maintenance processes.

These systems and methods typically need a higher level of integration with the engineering department (typically responsible for the expansion planning) and the logistics areas, which are typically aimed at coordinating any interventions that may be required for services rendered.

The repair and operations planning systems and methods may achieve a number of objectives, including supporting the strategic business planning through regular analyses and reviews of the level of service provided, thus assuring that the strategic planning initiative is feasible and is being fully executed.

The repair and operations planning systems and methods serve many purposes, and act as simplified operational plans by considering the inter-relations between various departments of a system. The departments can include any department depending on the type of data to be processed and the application for the system. For example, certain systems and applications may include an operations and maintenance department, an engineering department, a logistics department and supply data department, which can vary from one application or program to another. As a further example, if repair and operations planning systems and methods were developed for a chemical company, it is contemplated that other departments may be included to gather as data as necessary in order to effectuate the repair and operations plan. For example, this may include departments such as polymer department, pharmaceutical departments, governmental regulation departments and others as would be appreciated by those of ordinary skill in the art. It is to be appreciated that the systems and methods for repair and operations planning can be utilized for any industry.

An example of the usefulness of repair and operational plans can be found in effectively managing the changes between departments by assuming an active role in the face of changes and unexpected events, which differs from simply reacting to changes and unexpected events.

Indeed, repair and operations planning systems and methods in accordance with embodiments of the present invention allow companies to manage spare parts inventories and the services and products availability so as to allow for the continuity of the operation and of the revenues generated. In addition, repair and operations planning systems and methods allow companies to evaluate the performance of the maintenance planning process, as well as that of the service providers, identifying and sorting those activities that are out of control from those activities that can be controlled. By utilizing these systems and methods, a team work environment can be developed through the creation of conditions for each area to participate in the planning of operations.

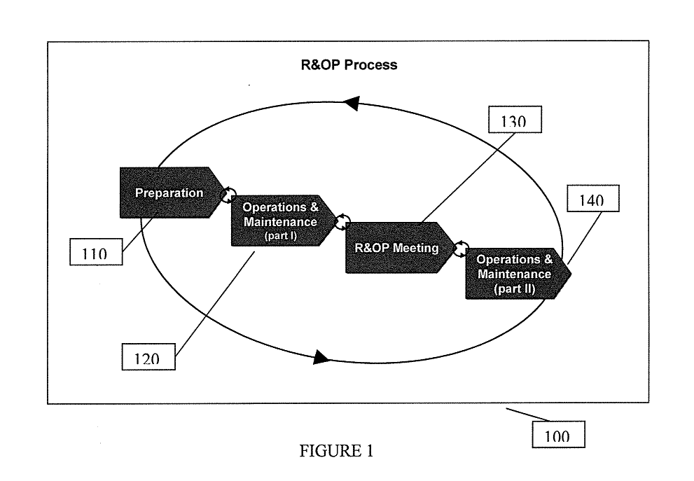

FIG. 1 illustrates one embodiment of a repair and operations planning system in accordance with the present invention. As can be seen, the entire system 100 may include four major steps: preparation 110, operations and maintenance (part I) 120, R&OP Meeting 130 and operations and maintenance (part II).

In preparation 110, a number of stage activities may occur. For example, any information generated from meetings should have a horizon of about one month, or until the next meeting. It is contemplated that any time frame could be utilized provided that it effectuates the proper result of conveying the correct amount of information between meetings. In some instances, for example in highly mobile and highly volatile industries, the horizon use could be as little as a few hours or a day.

In addition, preparation 110 may include the step of those that are involved in the R&OP meeting 130 preparing the determined inputs for each division or department, mapping the different problems during the implementation and updating the key performance indicators and also separating the information by category or product. It is contemplated that those persons attending the R&OP meeting 130 could also track other indicators and key success indicators for use in the monthly R&OP meeting.

Also, within preparation 110, all of the inputs, problems and the key performance indicators may be used to update the R&OP Reports/Status. Once updated, R&OP Reports/Status will be utilized in the third phase of the system of FIG. 1.

In addition, preparation 110 may include information from members regarding strategic aspects. These strategic aspects include supplier experiences, contract management, company size and capabilities, transportation strategies as well as others. It is to be appreciated that these strategic aspects are also dependent on the type of industry utilizing the repair and operations planning systems and methods. As such, different industries will utilize different key performance indicators depending on the type of information desired for repair and operations.

There are several types of key performance indicators, including, but not limited to: total inventory of the spare parts (in number of items and $$); number of preventive maintenance activities executed within the period; % of disruption in the services provided; loss of revenues due to the interruption of services; number of spare parts movements; penalties imposed to service providers for faulty maintenance; Mean Time between Failure (MTBF) and Mean Time to Repair (MTTR) of critical equipment.

It is to be appreciated that the preparation 110 phase of the repair and operations planning system may include other information that is relevant to the R&OP meeting 130 that can be assessed at the preparation 10 phase.

The information from the preparation 110 phase will then be sent to the operation and maintenance department for processing and utilization within the repair and operation planning system.

It is to be appreciated that within the preparation 110 phase, each area, division or department is responsible for collecting and reporting any information that is relevant for the R&OP meeting 130. It is once again to be appreciated that the number and title of each of the various departments may differ depending on the particular application and the particular industry for which the repair and operations planning system is being implemented.

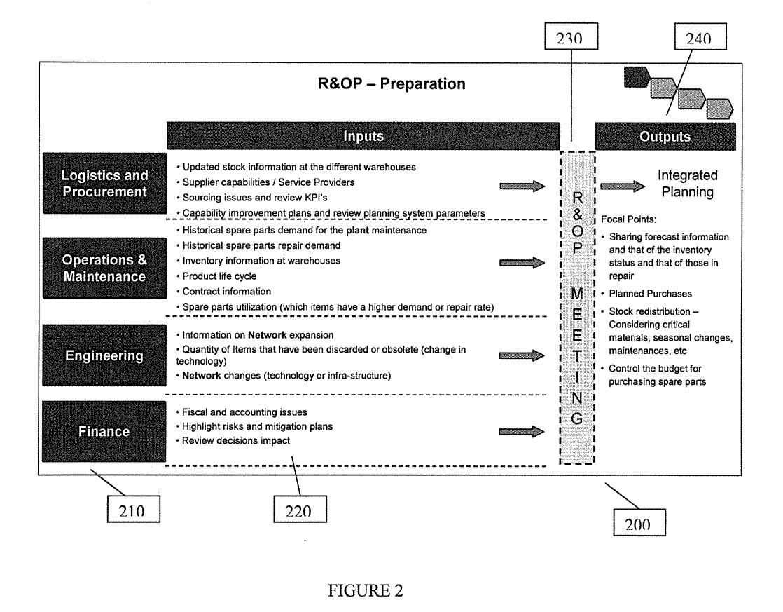

In one embodiment, as illustrated in FIG. 2, the repair and operations planning system includes departments 210 for input including: logistics and procurement, operations and maintenance, engineering and finance. Specific tasks 220 for the logistics and procurement include, among other tasks 220, updating stock information at the different warehouses, researching individual supplier capabilities as well as service providers. In addition, those under the logistics and procurement department will typically be responsible for maintaining the sourcing issues as well as reviewing the key performance indicators. As stated, those in the logistics and procurement division may also have many other tasks 220 to be accounted for, depending on the particular application.

Specific tasks 220 for the operations and maintenance department include, among other tasks, keeping historical track of spare parts demand for the maintenance of the plant, keeping historical spare parts repair demand, keeping inventory information at the warehouse(s), product life cycle(s), contract information and spare parts utilization (which in some instances, the spare parts have a higher demand or repair rate). As stated, those in the operations and maintenance division may also have many other tasks to be accounted for, depending on the particular application.

Specific tasks 220 for the engineering department include, among other tasks, gathering information on network expansion, researching the quantity of items that have been discarded or have been rendered obsolete due to a change in the technology and any network changes to the technology or the infra-structure. As stated, those in the engineering department may also have many other tasks to be accounted for, depending on the particular application.

Specific tasks 220 for the finance department include, among other tasks, fiscal and accounting issues, gathering information to allow the finance department to highlight risks and mitigation plans and reviewing any decisions impact on the company. As stated, those in the finance department may also have many other tasks to be accounted for, depending on the particular application.

As explained, there can be any number of departments 210 that provide inputs or tasks 220 for evaluation in the repair and operations planning system depending on the particular application being utilized. Once all of the inputs/tasks 220 have been made by the individual departments the collection of input from the different areas by the operations and maintenance (part I) occurs along with the generation of the agenda for R&OP meeting 230. Once all of the tasks 220 have been discussed at the R&OP meeting 230, an output 240, which in some instances will be in the form of Integrated Planning 240, will be produced. The outputs 240 include a number of focal points, including sharing forecast information and that of the inventory status and that of those in repair; planned purchases; stock redistribution and controlling the budget for purchasing spare parts.

In the operations and maintenance (part I) phase, numerous activities may occur within the repair and operations planning system. For example, the reports which include the inputs from each of the various departments is reviewed. From this review, a list of problems is recognized. A description of each of the problems is reviewed and each of the departments involved with that problem is identified. In addition, the impact of these problems on the overall process is evaluated.

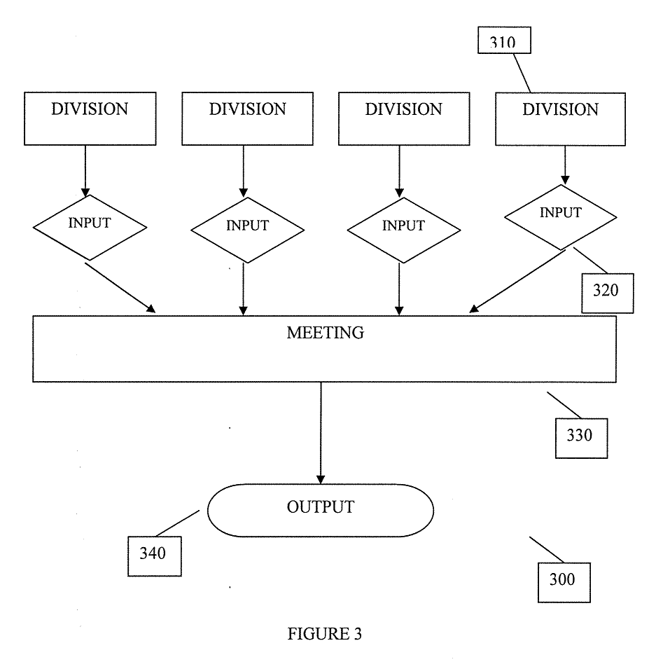

A more general illustration of the flowchart is shown in FIG. 3. As can be seen in this step of R&OP planning system 300, the individual divisions 310 provide input 320. As stated previously, it is contemplated that there be as many divisions as necessary to provide an efficient business system. As such, there may be as little as one division or as many as hundreds of divisions. Each input 320 is evaluated at the meeting 330. As a result of the meeting 330, an output 340 is determined. The output 340 may be in the form of integrated planning.

Preferably, all of the necessary information is received one week prior to the R&OP meeting. It is contemplated that any time frame could be utilized provided that it effectuates the proper result of conveying the correct amount of information between meetings. In some instances, for example in highly mobile and highly volatile industries, the time frame use could be as little as a few hours or a day.

Once the reports have been reviewed and the problem areas identified, the information is separated by category/product/code. When available, this is done using SAP. All of the information is then formatted into a report or agenda, which is then distributed to all of the R&OP meeting 230 participants.

It is to be appreciated that the operations and maintenance (part I) phase may include numerous other steps based on the inter-relations and the problems identified. For example, if two departments were identified as having over-lapping problems, it would be advantageous to identify any synergistic effects that the problems are creating. Furthermore, it is contemplated that other evaluations of identified problems would be included.

The next phase of repair and operations planning includes the R&OP meeting 230. The R&OP meeting 230 is preferably held once a month, and each monthly meeting focuses on a monthly horizon, or until the next meeting. It is contemplated that any time frame could be utilized provided that it effectuates the proper result of conveying the correct amount of information between meetings. In some instances, for example in highly mobile and highly volatile industries, the horizon use could be as little as a few hours or a day.

The meeting may be separated by product/category, since the material generated will typically be presented in the same manner. It is contemplated, however, that the material may be presented in a manner which is most convenient and as will likely be decided upon generation of the agenda in the operations and maintenance (part I).

In addition, the R&OP meeting will preferably include a review and modification of the actions agreed on in the previous meeting utilizing the previous R&OP reports, analyzing the list of problems and performance of the implementation of the planning.

Moreover, the restrictions and solutions of redistributing the spare parts inventory, stock visibility, the relationship with the supplier, seasonal demands, possible purchases for expansion purposes without spare parts surplus and others. Trade-offs between inputs can also be identified based on the agenda, including problem identification and benefits.

The R&OP meeting also preferably includes a discussion of the supplier evaluations with consideration to the strategic points considered by each of the different departments. By having all of the information from the different departments, it can be easier to determine where each supplier stands with regard to each department and how much overlap exists.

In addition, there will be a number of problems that can be identified but necessarily solved through the day to day efficiencies presented by the repair and operations planning system. Instead, certain of these problems must be directed to high management.

Once the above items have been discussed and the agenda analyzed, alternative scenario solutions can be developed and defined taking into consideration points brought up in the previous R&OP meeting as well as in the current.

As a result of the alternative scenario solutions and evaluations of the problems identified by each of the departments, the goals of each department likely must be realigned and the objectives for each department must be detailed.

Preferably, a meeting memo is generated which begins to define the integrated planning between the departments and maps out the future actions. Thus, as a result of the R&OP meeting, an integrated plan is mapped. The integrated plan includes a number of focal points, including, but not limited to, sharing forecast information and that of the inventory status and those in repair, planned purchases, stock redistribution (considering critical materials, seasonal changes, maintenances, etc.) and controlling the budget for purchasing spare parts.

In the last stage of the repair and operations planning system, the operations and maintenance (part II) 140 area preferably accompanies the execution of the meeting decisions and develop an integrated plan for the identified problem areas. In addition, this stage includes bi-weekly meetings, although it is contemplated that any time frame could be utilized provided that it effectuates the proper result of conveying the correct amount of information between meetings. In some instances, for example in highly mobile and highly volatile industries, the time frame use could be as little as a few hours or a day.

In addition, the operations and maintenance (part II) 140 phase accompany and execute the activities as determined in the R&OP meeting. Moreover, the resolutions that had been directed towards the executive committee are also accompanied.

In this phase, the integrated planning step preferably is defined. This can be accomplished by mapping the variations and performance between the implemented and the planned. In addition, to compensate for the variations identified as problematic, an plan of action is devised to divulge the plan to all involved departments. It is contemplated that additional meetings may be necessary in order to resolve pending or critical issues.

As stated, the repair and operations planning systems and methods of the present invention are applicable to any number of companies. For example, service providers that depend on the reliability of their equipment are the most benefited.

In executing the repair and operations planning systems and methods of embodiments of the present invention, the company's executive management may be involved in the process by both being present at the meetings and by having a high level of interaction in the decision making process. In addition, all areas affected, either directly or indirectly, by the maintenance planning and spare parts management activities may also be present at the meetings.

In addition, due to the numerous unfoldings and impacts deriving from the maintenance planning, R&OP meetings are constantly subject to losing their focus and to discussions about specific points of a lesser relevance. Hence, the planning of the meetings should be made so as to define an agenda aimed at the main discussion points and at preventing that issues of minor importance be given undue attention.

Besides making the responsibilities of each area's representatives clear within the process, a sponsor and a person responsible for the process as a whole may be defined. It is the sponsor's responsibility to maintain the level of attention of the whole company towards the process, the elimination of any possible barriers, the incorporation of any additional resources that may be necessary (people or systems) and, finally, the general support to the process. Given these responsibilities, mainly the need to manage any conflicts that may arise among the different areas and the need to maintain the company committed to the process, it may be important that the sponsor be among the main hierarchical levels of the company. Regarding the person responsible for the process, his or her main responsibility is to manage the execution of each one of the process stages, including the fulfillment of the defined time lines and the conduction of the planning meetings.

The R&OP meetings may include a definition of a planning horizon in which the meeting participants will base themselves on to make decisions such as procurement of spare parts, planning of preventive and corrective maintenance activities and changing of equipment. Support tools may be used to help in the decision making process and to analyze the repair history, the equipment's life cycle and to evaluate the performance of the service providers and vendors.

A company may have a tool for viewing the repair flow and the utilization of spare parts, comprising all the equipment maintenance and reverse logistics planning. This tool may be able to evaluate the impact of any possible changes on each one of the areas involved, as well as on the company as whole, by, for example, estimating the bottom-line results of the period being planned.

Typically, the level of formalization of a process is strongly related to the level of documentation of the process. Thus, the R&OP benchmark processes may document the maintenance planning activities, the participants, the responsibilities, time lines and goals of each process stage.

Also, to make the R&OP process an integrated process across the whole company, an efficient information flow among the areas involved in the process is required, both during the preparation stage and after the meeting.

Performance monitoring within the R&OP process preferably addresses both the performance of the process as a whole as well as the performance of the activities of each individual area involved in the process so that they too may have an impact on the process' final performance. Thus, it may be important to monitor the availability of the spare parts and stock levels, in addition to any possible disruptions in the service and the resulting loss in revenues.

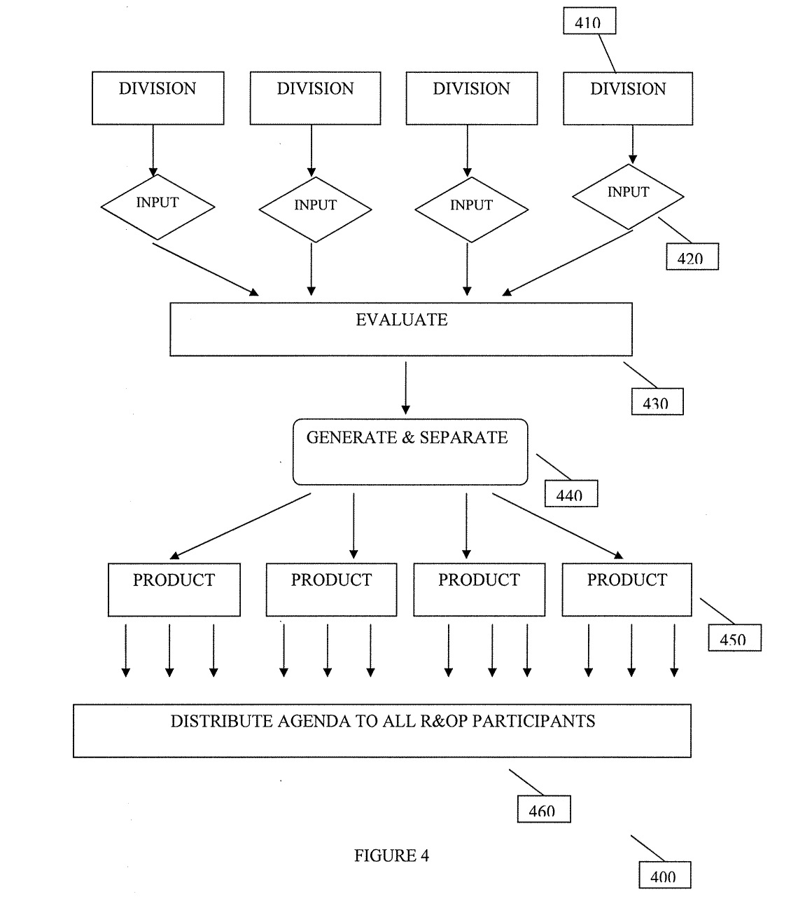

FIG. 4 illustrates a flowchart showing an example of a step 400 in a system for repair and operations planning in accordance with an embodiment of the invention. As shown, each division or department 410 provides input or task information 420. This input or task information 420 is evaluated 430. Once the task information 420 has been evaluated 430, each of the individual products is separated out and a plan, typically in the form of an agenda, is generated 440 for each individual product 450. The agenda regarding each product 450 is then distributed t to all of the R&OP meeting participants 460.

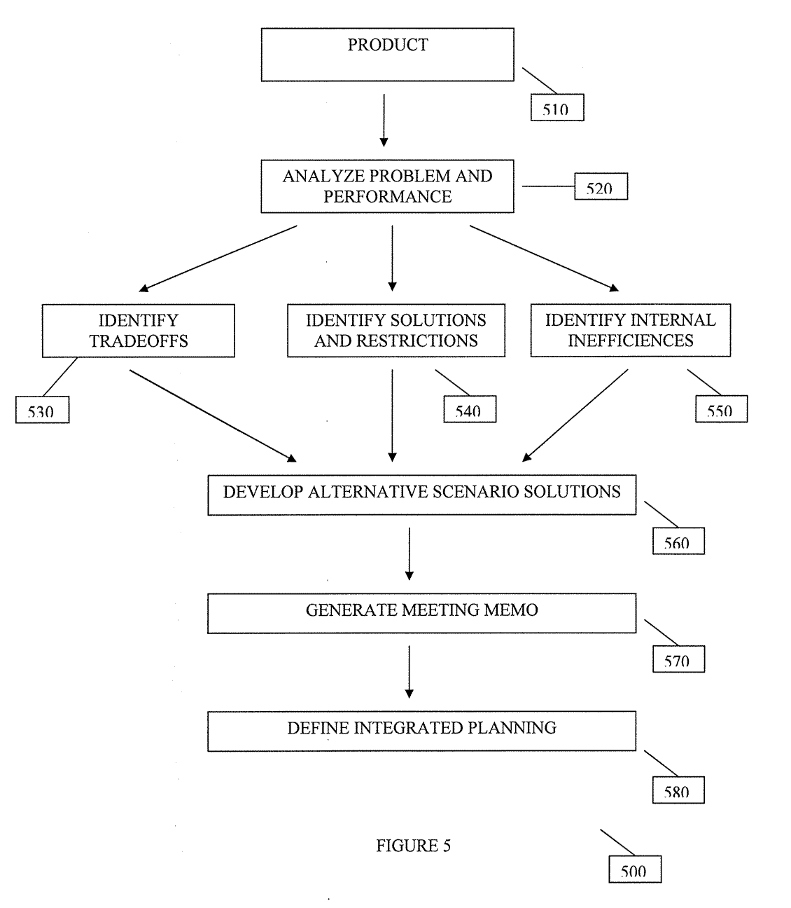

FIG. 5 illustrates a next step 500 in a repair and operations planning system in accordance with the invention. Once each product 510 has been analyzed and an agenda set for each, the problems and performance for that product is analyzed 520. The analysis includes identifying solutions and restrictions 540, as well as identifying internal inefficiencies 550, such as those problems with upper level management. Following these steps, alternative scenario solutions are identified 560. This leads to the generation of a meeting memo 570, which describes a plan of action to resolve the issues with the product 510. In some instances, integrated planning 580 will be defined as a result of the meeting memo 570.

As an example of a company utilizing the repair and operations planning process of the present invention includes telecommunication companies. Although applicable to both wireline and wireless, mainly wireline services were involved. The wireline services provided revenues from voice services that are stable, but need to offer services that operate 24 hours a day, 365 days a year. It is fundamental in this instance that the spare parts be available at the sites at a minimum quantity in case there is an interruption of services. Thus, to be efficient, a balance between the number of spare parts at a specific location is determined. For example, if there is an area that happens to need repair more than another area, it stands to reason to supply that area with more spare parts, in order to reduce the cost of transporting spare parts. The same applies to wireless companies regarding the maintenance of Base Transceiver Stations (BTS). Meanwhile, another outside factor to account for in this situation is that with recent mergers of telecommunications companies, the number of spare parts (fixed assets) of these companies has raised. Thus, the implementation of repair and operations planning systems and methods in accordance with embodiments of the present invention aim at evaluating, not only the network's spare parts inventory, but also all of the equipment involved in the data communication service. Thus, even if an inventory of spare parts were 150% larger than necessary, an operational cost for repairs could still be possible due to the transportation of spare parts to sites that did not have a surplus of spare parts.

Another application for repair and operations planning systems and methods in accordance with embodiments of the present invention relate to cable television. With the offer of additional services, including high speed internet access and telephone connection, cable television companies require their networks to be highly available.

Still another application for repair and operations planning systems and methods in accordance with embodiments of the present invention relate to transportation. Air, rail and subway transportation companies are very capital sensitive and the more time that an airplane or train is in operation, the asset utilization is more efficient. Planning preventative and corrective maintenance activities of airplanes and trains and the management of the spare parts inventory minimize the unproductive time and allow for the transportation of more passengers per asset per time unit.

Another application for repair and operations planning systems and methods in accordance with embodiments of the present invention relates to natural resources.

Natural resource businesses, such as oil and mining companies, have assets worth millions of dollars and that are responsible for extraction of thousands of barrels of oil or tons of minerals a day. Any disruption in the operation of this machinery translates into significant revenue that is lost. As such the repair and operations planning helps these companies to plan the maintenance activities and evaluate the spare parts inventory required for the operation to continue and to maintain the inventory in an efficient manner.

Other applications for repair and operations planning systems and methods in accordance with embodiments of the present invention relate to utilities and the aerospace sector.

The foregoing embodiments are to be considered in all respects illustrative rather than limiting the invention described herein. The invention has been described with reference to certain preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A method for repair and operations planning, the method including the steps of:
collecting input data from at least one department;
evaluating the input data; and
meeting to form an integrated plan to improve repair and operations efficiency.

2. The method of claim 1 wherein said input data differs for each department.

3. The method of claim 1 wherein said at least one department includes a logistics and procurement department.

4. The method of claim 1 wherein said at least one department includes an operations and maintenance department.

5. The method of claim 1 wherein said at least one department includes an engineering department.

6. The method of claim 1 wherein said at least one department includes a finance department.

7. The method of claim 1 wherein said at least one department includes a logistics and procurement department, an operations and maintenance department, an engineering department and a finance department.

8. The method of claim 1 wherein said input data is evaluated against a key performance indicator.

9. The method of claim 8 wherein said key performance indicator is selected from the group consisting of total inventory of the spare parts (in number of items and $$); number of preventive maintenance activities executed within the period; percent of disruption in the services provided; loss of revenues due to the interruption of services; number of spare parts movements; penalties imposed to service providers for faulty maintenance; Mean Time between Failure; Mean Time to Repair of critical equipment or combinations thereof.

10. The method of claim 1 wherein said integrated plan includes a focal point.

11. The method of claim 10 wherein said focal point is selected from the group consisting of sharing forecast information; inventory status; those in repair, planned purchases, stock redistribution; critical materials; seasonal changes; maintenances; controlling the budget for purchasing spare parts and combinations thereof.

12. The method of claim 1 wherein said meeting takes place monthly.

13. A system for improving maintenance planning for repair and operations, the system including:
a preparation phase whereby input data is collected from at least one department;
a first operations and maintenance phase whereby the input data is collected;
a repair and operations meeting phase whereby the input data is evaluated; and
a second operations and maintenance phase whereby an integrated plan is developed based on the evaluation of the input data.
